(19) United States
(12) Patent Application Publication
(10) Pub. No.: US 2024/0233762 A1
(43) Pub. Date: Jul. 11, 2024

(54) Magnetic Read Sensors Having Reduced Signal Imbalance

(71) Applicant: Western Digital Technologies, Inc., San Jose, CA (US)

(72) Inventors: Xiaoyong LIU, San Jose, CA (US); Songzi WANG, Shenzhen (CN); Ji LI, Shenzhen (CN); Yukimasa OKADA, Cupertino, CA (US)

(73) Assignee: Western Digital Technologies, Inc., San Jose, CA (US)

(21) Appl. No.: 18/308,576

(22) Filed: Apr. 27, 2023

(30) Foreign Application Priority Data
Jan. 5, 2023 (CH) 202310013524.3

(51) Int. Cl. G11B 5/73; G11B 5/11

(52) U.S. Cl. CPC G11B 5/737; G11B 5/11

(57) ABSTRACT

Aspects of the present disclosure generally relate to magnetic recording heads of magnetic recording devices, such as magnetic read sensors of magnetic read heads of hard disk drives (HDD). In one implementation, a reader includes a magnetic seed layer and a shield layer. Two free layers are disposed between the magnetic seed layer and the shield layer. The magnetic seed layer and the shield layer are magnetized in opposite directions. In one or more embodiments, each of the magnetic seed layer and the shield layer is magnetized using a simple pinning arrangement having an antiferromagnetic (AFM) layer. In one or more embodiments, one of the magnetic seed layer or the shield layer is magnetized using a simple pinning arrangement having an AFM) layer, and the other of the magnetic seed layer or the shield layer is magnetized using a synthetic antiferromagnetic (SAF) pinning arrangement having an AFM layer.

### CROSS REFERENCE TO RELATED APPLICATIONS

This application claims priority to China patent application serial number 202310013524.3, filed Jan. 5, 2023, which is herein incorporated by reference to its entirety.

### BACKGROUND OF THE DISCLOSURE

### Field of the Disclosure

Aspects of the present disclosure generally relate to magnetic recording heads of magnetic recording devices, such as magnetic read sensors of magnetic read heads of hard disk drives (HDD). In one or more implementations, a dual free layer read sensor is used.

### Description of the Related Art

The heart of the functioning and capability of a computer is the storing and writing of data to a data storage device, such as a hard disk drive (HDD). The volume of data processed by computers and server systems is increasing rapidly. There is a need for higher recording density of a magnetic recording medium to increase the function and the capability of computers/server systems.

Efforts can be made to achieve high resolution and recording densities, such as recording densities exceeding 2 Tbit/in² for a magnetic recording medium. Dual free layer (DFL) reader sensor has been introduced due to its better linear resolution from narrow read gap and reduced head instability. One characteristic of DFL is that the two free layers in the DFL have a finite down-track separation and opposite biasing in the cross-track direction. This results in relative larger and asymmetrical bumps in the signal cross-track profile comparing to single free layer (SFL).

Shingled magnetic recording (SMR) can be used to further push for cross-track track density (TPI). However, as SMR utilizes single side trimming, the asymmetrical bump of the DFL's cross-track signal profile is thus particularly unfavorable for SMR, as write quality differential based on shingle direction is increased. The imbalanced bumps/side lobe(s) in the signal cross-track profile(s) can lead to asymmetric side reading. Ultimately this can hinder the overall areal density capability (ADC) and/or sector error rates (SERs).

Therefore, there is a need in the art for an improved magnetic read head that facilitates reduced or eliminated side bump (or sidelobe) imbalance and enhanced reader performance.

### SUMMARY OF THE DISCLOSURE

Aspects of the present disclosure generally relate to magnetic recording heads of magnetic recording devices, such as magnetic read sensors of magnetic read heads of hard disk drives (HDD). In one or more implementations, a dual free layer read sensor is used. In one or more implementations, the read sensor is part of a two-dimensional magnetic recording (TDMR) read head.

In one implementation, a reader for magnetic recording devices includes a magnetic seed layer magnetized in a first direction, a shield layer magnetized in a second direction that is opposite of the first direction, and a first free layer disposed between the magnetic seed layer and the shield layer. The reader includes a second free layer disposed between the first free layer and the shield layer, a barrier layer disposed between the first free layer and the second free layer, and a first antiferromagnetic (AFM) layer disposed outwardly of the magnetic seed layer relative to the barrier layer. The reader includes a second AFM layer disposed outwardly of the shield layer relative to the barrier layer. The reader includes a first set of soft bias side shield layers between the magnetic seed layer and the shield layer, a second set of soft bias side shield layers between the first set of soft bias side shield layers and the shield layer, and a set of nonmagnetic spacer layers between the first set of soft bias side shield layers and the second set of soft bias side shield layers. The set of nonmagnetic spacer layers are formed of a nonmagnetic spacer material that is electrically conductive.

In one implementation, a read head for magnetic recording devices includes a lower reader. The lower reader includes a lower magnetic seed layer magnetized in a first direction, a lower shield layer magnetized in a second direction that is opposite of the first direction, and a first lower free layer disposed between the lower magnetic seed layer and the lower shield layer. The lower reader includes a second lower free layer disposed between the first lower free layer and the lower shield layer, a lower barrier layer disposed between the first lower free layer and the second lower free layer, and a first antiferromagnetic (AFM) layer disposed outwardly of the lower magnetic seed layer relative to the lower barrier layer. The lower reader includes a second AFM layer disposed outwardly of the lower shield layer relative to the lower barrier layer. The read head includes an upper reader. The upper reader includes an upper magnetic seed layer magnetized in the second direction, an upper shield layer magnetized in the first direction, and a first upper free layer disposed between the upper magnetic seed layer and the upper shield layer. The upper reader includes a second upper free layer disposed between the first upper free layer and the upper shield layer, and an upper barrier layer disposed between the first upper free layer and the second upper free layer. The upper reader includes a third AFM layer disposed between the upper magnetic seed layer and the second AFM layer, and a fourth AFM layer disposed outwardly of the upper shield layer relative to the upper barrier layer.

In one implementation, a read head for magnetic recording devices includes a lower reader. The lower reader includes a lower magnetic seed layer magnetized in a first direction, a lower shield layer magnetized in a second direction that is opposite of the first direction, and a first lower free layer disposed between the lower magnetic seed layer and the lower shield layer. The lower reader includes a second lower free layer disposed between the first lower free layer and the lower shield layer, a first antiferromagnetic (AFM) layer disposed outwardly of the lower magnetic seed layer, and a second AFM layer disposed outwardly of the lower shield layer. The lower reader includes a first lower set of soft bias side shield layers between the lower magnetic seed layer and the lower shield layer. The first lower set of soft bias side shield layers are magnetized in the first direction. The lower reader includes a second lower set of soft bias side shield layers between the first lower set of soft bias side shield layers and the lower shield layer. The second lower set of soft bias side shield layers are magnetized in the second direction. The lower reader includes a set of lower nonmagnetic spacer layers between the first lower set of soft bias side shield layers and the second lower set of soft bias side shield layers. The lower reader includes lower insulation material disposed between the first and second lower free layers on a first side of the lower insulation material and the first and second lower sets of soft bias side shield layers on a second side of the lower insulation material. The read head includes an upper reader. The upper reader includes an upper magnetic seed layer magnetized in the second direction, an upper shield layer magnetized in the first direction, and a first upper free layer disposed between the upper magnetic seed layer and the upper shield layer. The upper reader includes a second upper free layer disposed between the first upper free layer and the upper shield layer, a third AFM layer disposed between the upper magnetic seed layer and the second AFM layer, and a fourth AFM layer disposed outwardly of the upper shield layer. The upper reader includes a first upper set of soft bias side shield layers between the upper magnetic seed layer and the upper shield layer. The first upper set of soft bias side shield layers are magnetized in the second direction. The upper reader includes a second upper set of soft bias side shield layers between the first upper set of soft bias side shield layers and the upper shield layer. The second upper set of soft bias side shield layers are magnetized in the first direction, and a set of upper nonmagnetic spacer layers between the first upper set of soft bias side shield layers and the second upper set of soft bias side shield layers. The upper reader includes upper insulation material disposed between the first and second upper free layers on a first side of the upper insulation material and the first and second upper sets of soft bias side shield layers on a second side of the upper insulation material.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic view of a magnetic media drive having a magnetic write head and a magnetic read head, according to one implementation.

FIG. 2 is a schematic cross sectional side view of a head assembly 200 facing the magnetic disk or other magnetic storage medium, according to one implementation.

FIG. 3 is a schematic MFS view of a reader for magnetic recording devices, according to one implementation.

FIG. 4 is a schematic MFS view of a reader for magnetic recording devices, according to one implementation.

FIG. 5 is a schematic MFS view of a reader for magnetic recording devices, according to one implementation.

FIG. 6 is a schematic MFS view of a read head for magnetic recording devices, according to one implementation.

FIG. 7 is a schematic MFS view of a read head for magnetic recording devices, according to one implementation.

FIG. 8 is a schematic cross-sectional side view of the read head shown in FIG. 7, according to one implementation.

FIG. 9 is a schematic isometric view of the read head shown in FIG. 7, according to one implementation.

FIG. 10 is a schematic graphical view of a graph showing signal amplitude versus cross-track offset (e.g., cross-track profile).

FIG. 11 is a schematic graphical view of a graph showing areal density capability (ADC) and sector error rate (SER), respectively, versus cross-track signal sidebump (e.g., sidelobe) imbalance.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure generally relate to magnetic recording heads of magnetic recording devices, such as magnetic read sensors of magnetic read heads of hard disk drives (HDD). In one or more implementations, a dual free layer read sensor is used. In one or more implementations, the read sensor is part of a two-dimensional magnetic recording (TDMR) read head. In one implementation, a reader includes a magnetic seed layer and a shield layer. In one or more embodiments, the magnetic seed layer is part of a lower shield and the shield layer is a top shield layer. Two free layers are disposed between the magnetic seed layer and the shield layer. The magnetic seed layer and the shield layer are magnetized in opposite directions. In one or more embodiments, each of the magnetic seed layer and the shield layer is magnetized using a simple pinning arrangement having an antiferromagnetic (AFM) layer. In one or more embodiments, one of the magnetic seed layer or the shield layer is magnetized using a simple pinning arrangement having an AFM) layer, and the other of the magnetic seed layer or the shield layer is magnetized using a synthetic antiferromagnetic (SAF) pinning arrangement having an AFM layer.

It is to be understood that the magnetic recording head discussed herein is applicable to a data storage device such as a hard disk drive (HDD) as well as a tape drive such as a tape embedded drive (TED) or an insertable tape media drive. An example TED is described in co-pending patent application titled “Tape Embedded Drive,” U.S. Pat. No. 10,991,390, issued on Apr. 27, 2021, assigned to the same assignee of this application, which is herein incorporated by reference. As such, any reference in the detailed description to a HDD or tape drive is merely for exemplification purposes and is not intended to limit the disclosure unless explicitly claimed. Furthermore, reference to or claims directed to magnetic recording devices are intended to include both HDD and tape drive unless HDD or tape drive devices are explicitly claimed.

It is also to be understood that aspects disclosed herein, such as the magnetoresistive devices, may be used in magnetic sensor applications outside of HDD's and tape media drives such as TED's, such as spintronic devices other than HDD's and tape media drives. As an example, aspects disclosed herein may be used in magnetic elements in magnetoresistive random-access memory (MRAM) devices (e.g., magnetic tunnel junctions as part of memory elements), magnetic sensors or other spintronic devices. It should be noted that while the term “reader” or “read head” are used to described various embodiments shown below, those skilled in the art will recognize the disclosed stacks and structures can be considered as a sensor or magnetic tunnel junction, or part of a sensor or magnetic tunnel junction. Thus the scope of disclosure is intended to cover those implementations as well.

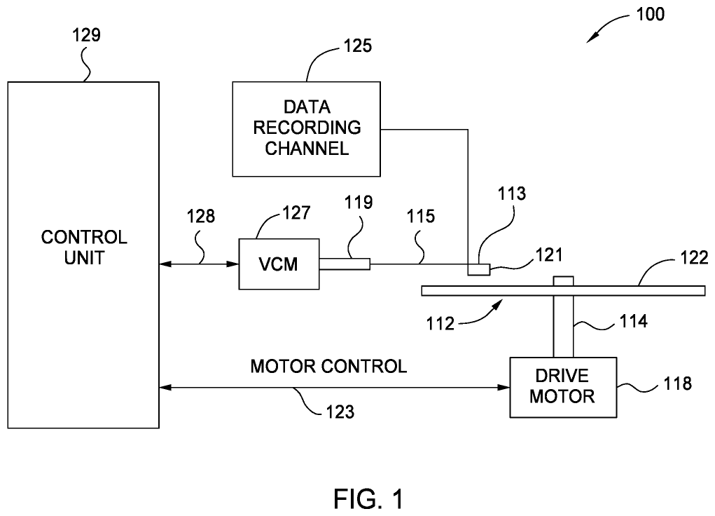

FIG. 1 is a schematic view of a magnetic media drive 100 having a magnetic write head and a magnetic read head, according to one implementation. The magnetic media drive 100 may be a single drive/device or may include multiple drives/devices. The magnetic media drive 100 includes a magnetic recording medium, such as one or more rotatable magnetic disk 112 supported on a spindle 114 and rotated by a drive motor 118. For the ease of illustration, a single disk drive is shown according to one implementation. The magnetic recording on each magnetic disk 112 is in the form of any suitable patterns of data tracks, such as annular patterns of concentric data tracks (not shown) on the magnetic disk 112.

At least one slider 113 is positioned near the magnetic disk 112. Each slider 113 supports a head assembly 121 including one or more read/write heads, such as a write head and a read head having a two-dimensional magnetic recording (TDMR) device. As the magnetic disk 112 rotates, the slider 113 moves radially in and out over the disk surface 122 so that the head assembly 121 may access different tracks of the magnetic disk 112 where desired data are written or read. Each slider 113 is attached to an actuator arm 119 by way of a suspension 115. The suspension 115 provides a slight spring force which biases the slider 113 toward the disk surface 122. Each actuator arm 119 is attached to an actuator 127. The actuator 127 as shown in FIG. 1 may be a voice coil motor (VCM). The VCM includes a coil movable within a fixed magnetic field. The direction and speed of the coil movements are controlled by the motor current signals supplied by control unit 129.

During operation of the magnetic media drive 100, the rotation of the magnetic disk 112 generates an air or gas bearing between the slider 113 and the disk surface 122 which exerts an upward force or lift on the slider 113. The air or gas bearing thus counter-balances the slight spring force of suspension 115 and supports slider 113 off and slightly above the disk surface 122 by a small, substantially constant spacing during normal operation.

The various components of the magnetic media drive 100 are controlled in operation by control signals generated by control unit 129, such as access control signals and internal clock signals. The control unit 129 includes logic control circuits, storage means, and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from the head assembly 121 by way of recording channel 125. The magnetic media drive 100 of FIG. 1 may include a plurality of media (or disks), a plurality of actuators, and/or a plurality of sliders.

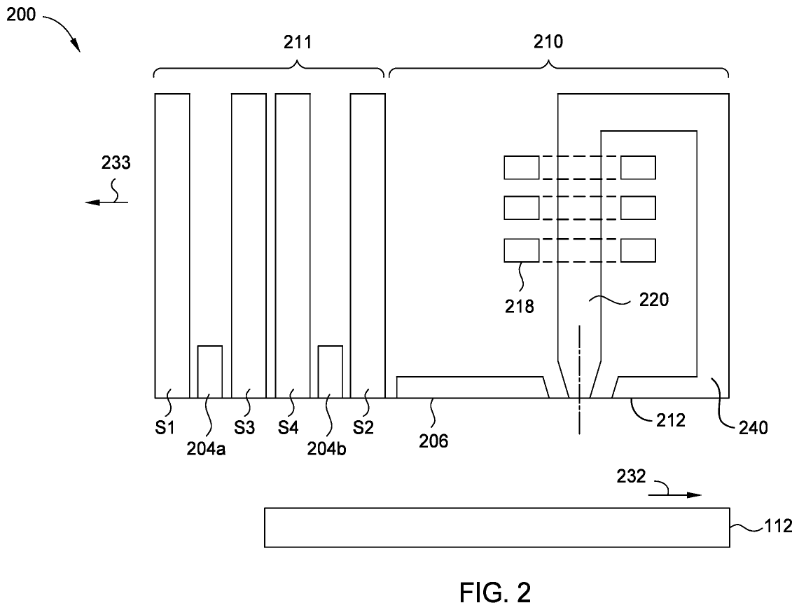

FIG. 2 is a schematic cross sectional side view of a head assembly 200 facing the magnetic disk 112 or other magnetic storage medium, according to one implementation. The head assembly 200 may correspond to, or be used as, the head assembly 121 shown in FIG. 1. The head assembly 200 includes a media facing surface (MFS) 212, such as an air bearing surface (ABS), facing the magnetic disk 112. As shown in FIG. 2, the magnetic disk 112 relatively moves in the direction indicated by the arrow 232 and the head assembly 200 relatively moves in the direction indicated by the arrow 233.

The head assembly 200 includes a magnetic read head 211. The magnetic read head 211 includes a first sensing element 204a disposed between shields S1 and S3, S4, as well as a second sensing element 204b disposed between shields S2 and S3, S4. The sensing elements 204a, 204b and the shields S1, S2, S3, and S4 all have surfaces at the MFS 212 facing the magnetic disk 112. In one embodiment, which can be combined with other embodiments, the sensing elements 204a, 204b are devices in TDMR configuration sensing the magnetic fields of the recorded bits (such as perpendicularly recorded bits or longitudinally recorded bits) in the magnetic disk 112, their output signals of which are processed under the principles of TDMR. In one embodiment, which can be combined with other embodiments, the spacing between shields S1 and S3 is about 25 nm or less (such as about 17 nm or less), the spacing between shields S3 and S4 is about 30 nm or less, and/or the spacing between shields S4 and S2 is about 25 nm or less (such as about 17 nm or less). In one or more embodiments, only one sensing element and its associated shields are present for a non-TDMR approach. In one or more embodiments, more than two sensing elements and their associated shields are present under a TDMR approach.

The head assembly 200 may include a write head 210. The write head 210 includes a main pole 220, a leading shield 206, and a trailing shield (TS) 240. The main pole 220 includes a magnetic material and serves as a main electrode. Each of the main pole 220, the leading shield 206, and the TS 240 has a front portion at the MFS 212. The write head 210 includes a coil 218 around the main pole 220 that excites the main pole 220 producing a writing magnetic field for affecting a magnetic recording medium of the rotatable magnetic disk 112. The coil 218 may be a helical structure or one or more sets of pancake structures. The TS 240 comprises a magnetic material, serving as a return pole for the main pole 220. The leading shield 206 may provide electromagnetic shielding and is separated from the main pole 220 by a leading gap 254.

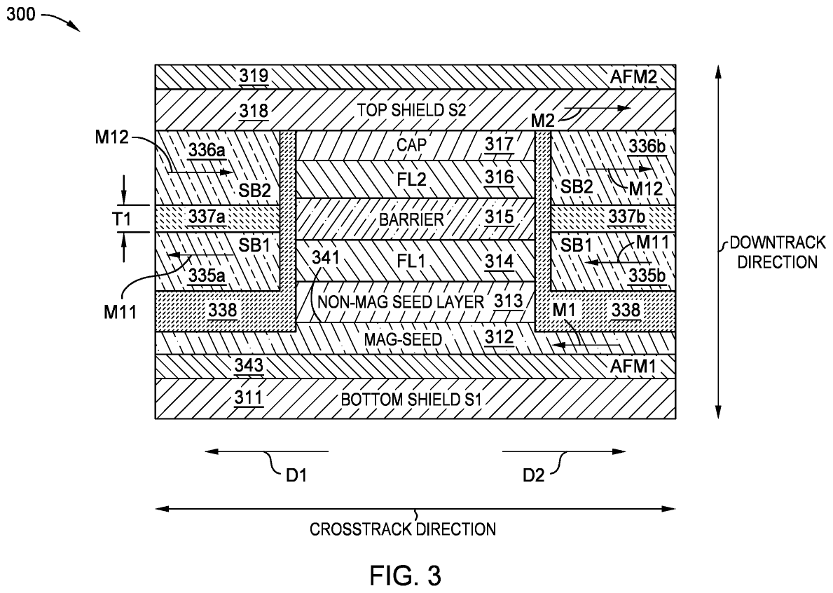

FIG. 3 is a schematic MFS view of a reader 300 for magnetic recording devices, according to one implementation. The reader 300 can be part of a magnetic recording device, such as the magnetic media drive 100 shown in FIG. 1 and/or the magnetic recording head shown in FIG. 2.

The reader 300 includes a magnetic seed layer 312 magnetized in a first direction D1 (as shown by magnetization M1), and a shield layer 318 magnetized in a second direction D2 (as shown by magnetization M2) that is opposite of (e.g., antiparallel to) the first direction D1. In one or more embodiments, the magnetic seed layer 312 and a bottom shield layer 311 are at least part of a lower shield, and the shield layer 318 is a top shield layer that is at least part of an upper shield. The present disclosure contemplates that the bottom shield layer 311 can be omitted. The lower shield can be a plated bulk shield. The reader 300 includes a first free layer 314 disposed between the magnetic seed layer 312 and the shield layer 318, a second free layer 316 disposed between the first free layer 314 and the shield layer 318. The reader 300 includes a barrier layer 315 disposed between the first free layer 314 and the second free layer 316. The reader 300 includes a first antiferromagnetic (AFM) layer 343 disposed outwardly of the magnetic seed layer 312 relative to the barrier layer 315, and a second AFM layer 319 disposed outwardly of the shield layer 318 relative to the barrier layer 315. The first AFM layer 343 interfaces with the magnetic seed layer 312, and the second AFM layer 319 interfaces with the shield layer 318. In one or more embodiments, the first AFM layer 343 has a first blocking temperature and the second AFM layer 319 has a second blocking temperature that is different than the first blocking temperature. In one or more embodiments, the second blocking temperature (for AFM layer 319) is greater than the first blocking temperature (for AFM layer 343). Different blocking temperatures can be established by different thicknesses (e.g., along the downtrack direction), different materials, differing use of plating(s), and/or different growth techniques for the AFM layers. In one or more embodiments, plated manganese (Mn) can be used on one of the AFM layers to establish a differing blocking temperature between the AFM layers. In one or more embodiments, the second blocking temperature is the same as the first blocking temperature.

The reader 300 includes a nonmagnetic seed layer 313 disposed between the magnetic seed layer 312 and the first free layer 314, and a nonmagnetic cap layer 317 disposed between the second free layer 316 and the shield layer 318.

The first free layer 314 is separated from the magnetic seed layer 312 by at least the non-magnetic seed layer 313. The second free layer 316 is separated from the shield layer 318 by at least the cap layer 317. Such separation(s) facilitate reducing the direct magnetic coupling from shields (such as the magnetic seed layer 312 and the shield layer 318) to free layers.

The reader 300 includes a first set of soft bias side shield layers 335a, 335b between the magnetic seed layer 312 and nonmagnetic spacer layers 337a, 337b, and a second set of soft bias side shield layers 336a, 336b between the nonmagnetic spacer layers 337a, 337b and the shield layer 318. Thus, the set of nonmagnetic spacer layers 337a, 337b are between the first set of soft bias side shield layers 335a, 335b and the second set of soft bias side shield layers 336a, 336b. A thickness T1 of each of the set of nonmagnetic spacer layers 337a, 337b is less than 10 Angstroms. In one or more embodiments, the T1 thickness is selected (e.g., tuned) to make the first and second sets of soft bias side shield layers 335a, 335b, 336a, 336b antiparallel coupled to each other through RKKY interaction. In one or more embodiments, the thickness T1 is within a range of 4 Angstroms to 8 Angstroms. The reader 300 includes an insulation material 338 between the first set of soft bias side shield layers 335a, 335b and the magnetic seed layer 312. The insulation material 338 is also disposed between layers 313-317 (on a first side of the respective insulation material 338) and soft bias side shield layers 335a, 335b, 336a, 336b (on a second side of the respective insulation material 338).

In the implementation shown in FIG. 3, a magnetic field is applied to the reader 300 (e.g., during an annealing operation or a cooling operation) in the second direction D2. The present disclosure contemplates that the magnetic field can be applied to the reader 300 (e.g., during an annealing operation or a cooling operation) in the first direction D1.

In the implementation shown in FIG. 3, each of the magnetic seed layer 312 and the shield layer 318 is pinned using an annealing operation or a field cooling operation that includes heating or cooling the respective first AFM layer 343 or second AFM layer 319. Because the first and second AFM layers 343 and 319 have two different blocking temperatures, during cooling of a temperature towards a second blocking temperature field is applied to the AFM layers 319, 343 in the second direction D2, and when the temperature is less than the second blocking temperature but larger than a first blocking temperature, the field is aligned to the first direction D1.

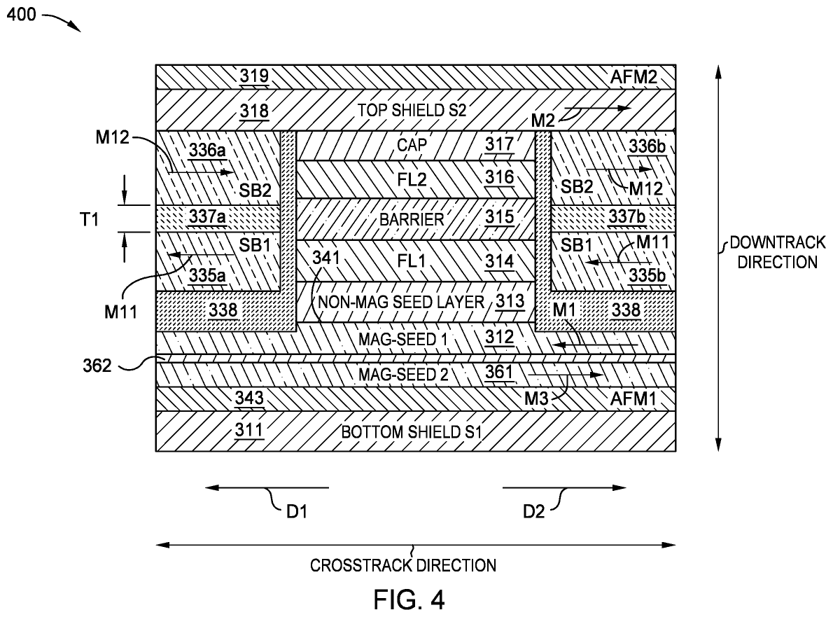

FIG. 4 is a schematic MFS view of a reader 400 for magnetic recording devices, according to one implementation. The reader 400 can be part of a magnetic recording device, such as the magnetic media drive 100 shown in FIG. 1 and/or the magnetic recording head shown in FIG. 2. The reader 400 can be similar to the reader 300 shown in FIG. 3, and can include one or more aspects, features, operations, properties, and/or components thereof. As an example, the reader 400 includes the first free layer 314 and the second free layer 316.

In the implementation shown in FIG. 4, the reader 400 includes a second magnetic seed layer 361 disposed between the magnetic seed layer 312 and the first AFM layer 343. The second magnetic seed layer 361 is magnetized in the second direction D2 (as shown by magnetization M3). The reader 400 includes a nonmagnetic spacer layer 362 with thickness of T1 disposed between the magnetic seed layer 312 and the second magnetic seed layer 361. A thickness T1 is less than 10 Angstroms. In one or more embodiments, the T1 thickness is selected (e.g., tuned) to make the two magnetic seed layers 361 and 312 antiparallel coupled to each other through RKKY interaction.

In the implementation shown in FIG. 4, the magnetic seed layer 312 is pinned using a synthetic antiferromagnetic (SAF) pinning arrangement that includes the second magnetic seed layer 361 and the first AFM layer 343. The shield layer 318 is pinned using a simple pinning arrangement that includes the second AFM layer 319. In such an implementation, the second AFM layer 319 and the first AFM layer 343 can be made of the same material and have the same blocking temperatures.

In the implementation shown in FIG. 4, a magnetic field is applied to the reader 400 (e.g., during an annealing operation or a cooling operation) in the second direction D2. The present disclosure contemplates that the magnetic field can be applied to the reader 400 (e.g., during an annealing operation or a cooling operation) in the first direction D1.

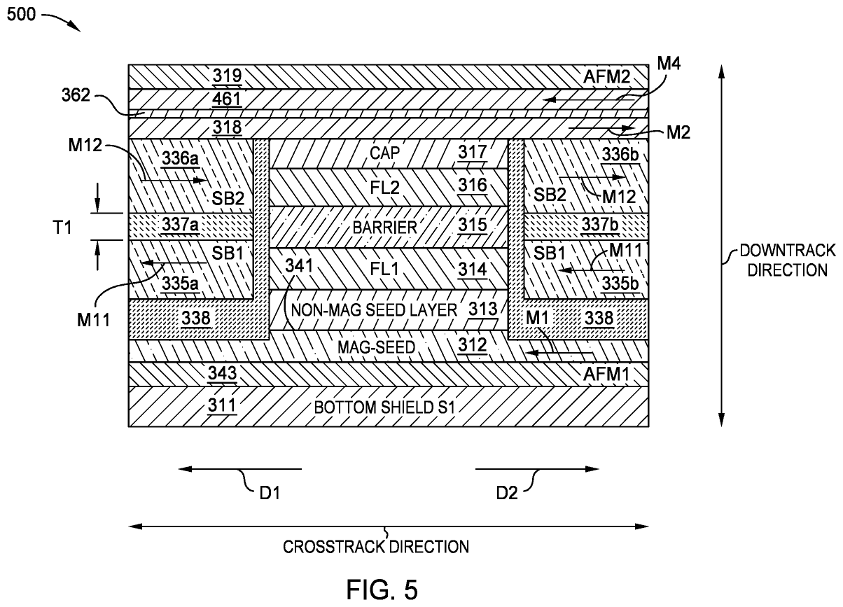

FIG. 5 is a schematic MFS view of a reader 500 for magnetic recording devices, according to one implementation. The reader 500 can be part of a magnetic recording device, such as the magnetic media drive 100 shown in FIG. 1 and/or the magnetic recording head shown in FIG. 2. The reader 500 can be similar to the reader 400 shown in FIG. 4, and can include one or more aspects, features, operations, properties, and/or components thereof. As an example, the reader 500 includes the first free layer 314 and the second free layer 316.

In the implementation shown in FIG. 5, the reader 500 includes a second shield layer 461 disposed between the shield layer 318 and the second AFM layer 319. The second shield layer 461 is magnetized in the first direction D1 (as shown by magnetization M4). In the implementation shown in FIG. 5, the nonmagnetic spacer layer 362 with a thickness T2 is disposed between the shield layer 318 and the second shield layer 461. The thickness T2 is less than 10 Angstroms. In one or more embodiments, the thickness T2 is selected (e.g., tuned) to make the second shield layer 461 and the shield layer 318 antiparallel coupled to each other through RKKY interaction.

In the implementation shown in FIG. 5, the shield layer 318 is pinned using a synthetic antiferromagnetic (SAF) pinning arrangement that includes the second shield layer 461 and the second AFM layer 319. The magnetic seed layer 312 is pinned using a simple pinning arrangement that includes the first AFM layer 343. In such an implementation, the first AFM layer 343 and the second AFM layer 319 can be made of the same material with the same blocking temperatures.

In the implementation shown in FIG. 5, a magnetic field is applied to the reader 500 (e.g., during an annealing operation or a cooling operation) in the first direction D1. The present disclosure contemplates that the magnetic field can be applied to the reader 500 (e.g., during an annealing operation or a cooling operation) in the second direction D2.

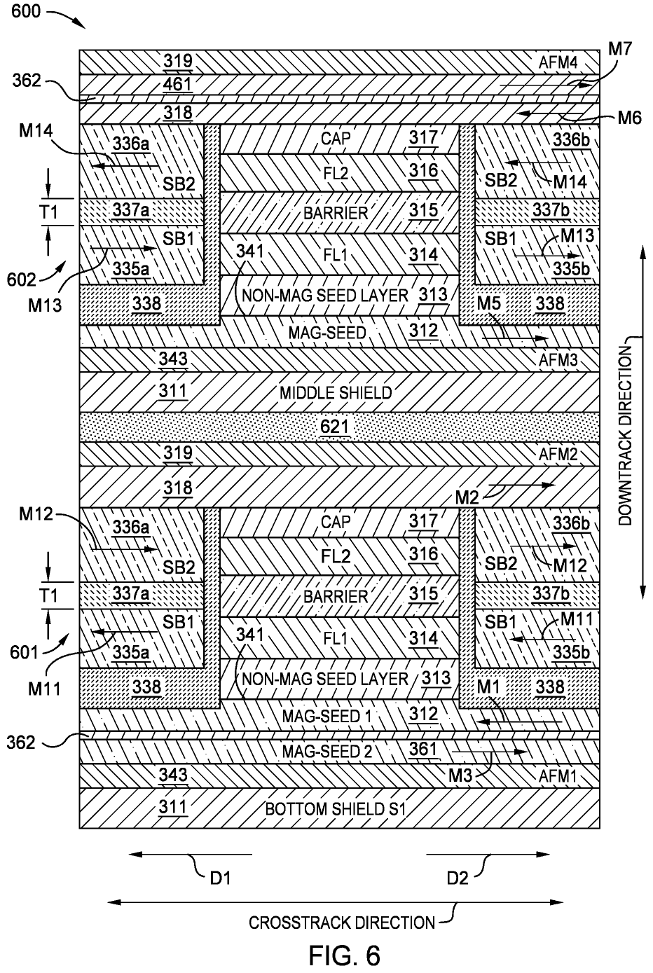

FIG. 6 is a schematic MFS view of a read head 600 for magnetic recording devices, according to one implementation. The read head 600 can be part of a magnetic recording device, such as the magnetic media drive 100 shown in FIG. 1 and/or the magnetic recording head shown in FIG. 2.

The read head 600 is a TDMR (two dimensional magnetic recording) read head which includes a lower reader 601 and an upper reader 602. In the implementation shown in FIG. 6, the lower reader 601 includes the implementation of the reader 400 shown in FIG. 4. The upper reader 602 is similar to the implementation of the reader 500 shown in FIG. 5. The upper reader 602 is disposed above the lower reader 601 in a downtrack direction. In one or more embodiments, there is at least some offset (e.g., less than 10 nm) in the cross-track direction between the upper reader 602 and the lower reader 601.

The components of the lower reader 601 can be referred to as “lower” versions of the components of the reader 400 shown in FIG. 4, and the components of the upper reader 602 can be referred to as “upper” versions of the components of the reader 500 shown in FIG. 5. As an example, the magnetic seed layer 312 of the lower reader 601 can be referred to as a lower magnetic seed layer, and the magnetic seed layer 312 of the upper reader 602 can be referred to as an upper magnetic seed layer. As another example, the second magnetic seed layer 361 of the lower reader 601 can be referred to as second lower magnetic seed layer, and the nonmagnetic spacer layer 362 of the lower reader 601 can be referred to as a lower nonmagnetic spacer layer. As another example, the second shield layer 461 of the upper reader 602 can be referred to as a second upper shield layer, and the nonmagnetic spacer layer 362 of the upper reader 602 can be referred to as an upper nonmagnetic spacer layer.

As another example, the first free layer 314 of the lower reader 601 can be referred to as a first lower free layer, and the second free layer 316 of the lower reader 601 can be referred to as a second lower free layer. As another example, the first free layer 314 of the upper reader 602 can be referred to as a first upper free layer, and the second free layer 316 of the upper reader 602 can be referred to as a second upper free layer. As another example, the barrier layer 315 of the lower reader 601 can be referred to as a lower barrier layer, and the barrier layer 315 of the upper reader 602 can be referred to as an upper barrier layer.

As another example, the first set of soft bias side shield layers 335a, 335b of the lower reader 601 can be referred to as a first lower set of soft bias side shield layers, and the second set of soft bias side shield layers 336a, 336b of the lower reader 601 can be referred to as a second lower set of soft bias side shield layers. The nonmagnetic spacer layers 337a, 337b of the lower reader 601 can be referred to as a set of lower nonmagnetic spacer layers. Additionally, the first set of soft bias side shield layers 335a, 335b of the upper reader 602 can be referred to as a first upper set of soft bias side shield layers, and the second set of soft bias side shield layers 336a, 336b of the upper reader 602 can be referred to as a second upper set of soft bias side shield layers. The nonmagnetic spacer layers 337a, 337b of the upper reader 602 can be referred to as a set of upper nonmagnetic spacer layers. As a further example, the insulation material 338 of the lower reader 601 can be referred to as lower insulation material, and the insulation material 338 of the upper reader 602 can be referred to as upper insulation material.

In the implementation shown in FIG. 6, the first set of soft bias side shield layers 335a, 335b of the upper reader 602 are magnetized in a direction (e.g., the second direction D2, as shown by magnetizations M13) that is opposite of the magnetizations (in the first direction D1, as shown by magnetizations M11) of the first set of soft bias side shield layers 335a, 335b of the lower reader 601. The second set of soft bias side shield layers 336a, 336b of the upper reader 702 are magnetized in a direction (e.g., the first direction D1, as shown by magnetizations M14) that is opposite of the magnetizations (in the second direction D2, as shown by magnetizations M12) of the second set of soft bias side shield layers 336a, 336b of the lower reader 601. Such an implementation facilitates using a simple annealing and/or cooling operation to reset the magnetizations of the AFM layers of the read head 600, such as a single annealing and/or cooling operation to reset the magnetizations of all AFM layers of the read head 600.

In the implementation of the read head 600 shown in FIG. 6, the first AFM layer 343 of the upper reader 602 can be referred to as a third AFM layer disposed between the upper magnetic seed layer 312 (of the upper reader 602) and the second AFM layer 319 (of the lower reader 601). The second AFM layer 319 of the upper reader 602 can be referred to as a fourth AFM layer. The third AFM layer and the fourth AFM layer are used in addition to the first AFM layer 343 and the second AFM layer 319 of the lower reader 601.

The read head 600 includes a middle shield layer disposed between the second AFM layer 319 (of the lower reader 601) and the third AFM layer (which is the first AFM layer 343 of the upper reader 602). In the implementation shown in FIG. 6, the middle shield layer is the bottom shield layer 311 of the upper reader 602. In one or more embodiments, the middle shield layer (e.g., bottom shield layer 311) and the second magnetic seed layer 312 are at least part of a bottom shield for the upper reader 602.

The first AFM layer 343 (of the lower reader 601) interfaces with the second lower magnetic seed layer (which is the second magnetic seed layer 361 of the lower reader 601). The second AFM layer 319 (of the lower reader 601) interfaces with the lower shield layer (which is the shield layer 318 of the lower reader 601). The third AFM layer (which is the first AFM layer 343 of the upper reader 602) interfaces with the upper magnetic seed layer (which is the magnetic seed layer 312 of the upper reader 602) and optionally interfaces with the middle shield layer (which is the bottom shield layer 311 of the upper reader 602). The present disclosure contemplates that a non-magnetic layer can be disposed between the third AFM layer and the middle shield layer such that the third AFM layer interfaces with the non-magnetic layer. The fourth AFM layer (which is the second AFM layer 319 of the upper reader 602) interfaces with the second upper shield layer (which is the second shield layer 461 of the upper reader 602).

As shown by magnetizations M5, M7, the magnetic seed layer 312 of the upper reader 602 and the second shield layer 461 of the upper reader 602 are magnetized in a direction (e.g., the second direction D2) that is opposite of the magnetization M1 of the magnetic seed layer 312 of the lower reader 601. As shown by magnetization M6, the shield layer 318 of the upper reader 602 is magnetized in a direction (e.g., the first direction D1) that is that same as the magnetization M1 of the magnetic seed layer 312 of the lower reader 601. Magnetization M6 and magnetization M5 of the upper reader 602 are antiparallel with each other, and magnetization M2 and magnetization M1 of the lower reader 601 are antiparallel with each other, as shown in FIG. 6.

The read head 600 includes an insulating separation layer 621 between the upper reader 602 and the lower reader 601.

The implementation shown in FIG. 6 includes two simple pinned arrangements (involving the second AFM layer and the third AFM layer) at interfaces between the lower reader 601 and the upper reader 602, and two SAF pinned arrangements (involving the first AFM layer and the fourth AFM layer) outwardly of the lower reader 601 and the upper reader 602. Such an implementation (e.g., using a simple pinned arrangement on one side of each reader and using an SAF pinned arrangement on the other side of each reader) facilitates using smaller downtrack separation between the upper reader 602 and the lower reader 601 while reducing or eliminating imbalances of read signal sidebump amplitudes when using the lower reader 601 and the upper reader 602. Such an implementation also facilitates using a simple annealing and/or field cooling operation to reset the magnetizations of the AFM layers of the read head 600, such as a single annealing and/or cooling operation to reset the magnetizations of all AFM layers of the read head 600. In one or more embodiments, all four AFM layers of the read head 600 have the same blocking temperature such that the magnetizations of the four AFM layers can be reset with a single anneal and/or cooling operation.

In the implementation shown in FIG. 6, the first AFM layer pins the second magnetic seed layer 361 of the lower reader 601, the second AFM layer pins the shield layer 318 of the lower reader 601, the third AFM layer pins the magnetic seed layer 312 of the upper reader 602, and the fourth AFM layer pins the second shield layer 461 of the upper reader 602.

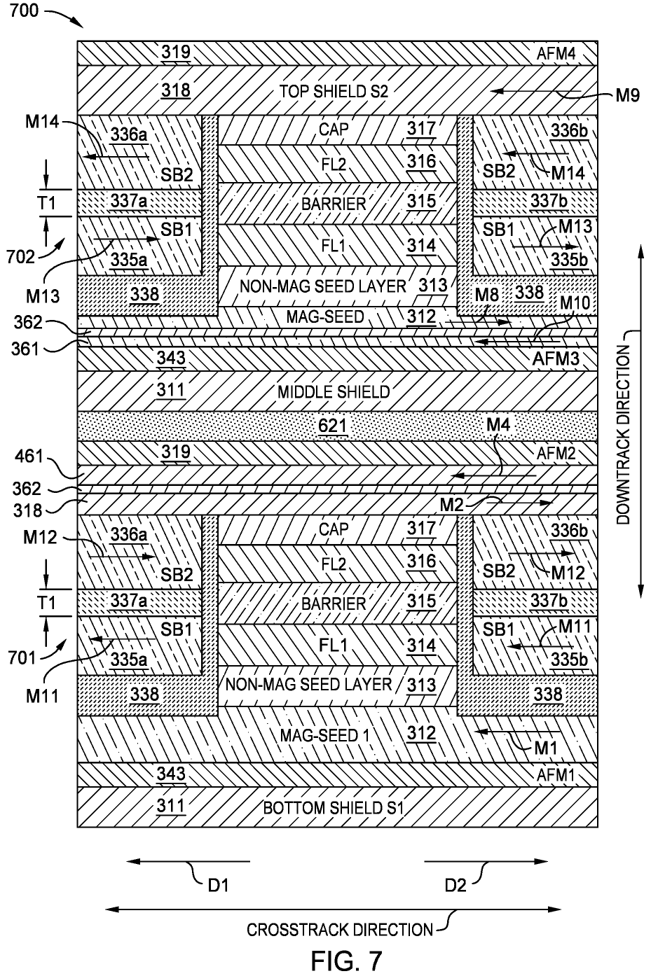

FIG. 7 is a schematic MFS view of a read head 700 for magnetic recording devices, according to one implementation. The read head 700 can be part of a magnetic recording device, such as the magnetic media drive 100 shown in FIG. 1 and/or the magnetic recording head shown in FIG. 2.

The read head 700 is a TDMR reader and includes a lower reader 701 and an upper reader 702. In the implementation shown in FIG. 7, the lower reader 701 includes the implementation of the reader 500 shown in FIG. 5. The upper reader 702 is similar to the implementation of the reader 400 shown in FIG. 4. The upper reader 702 is disposed above the lower reader 701 in a downtrack direction.

The components of the lower reader 701 can be referred to as “lower” versions of the components of the reader 500 shown in FIG. 5, and the components of the upper reader 702 can be referred to as “upper” versions of the components of the reader 400 shown in FIG. 4.

As an example, the shield layer 318 of the lower reader 701 can be referred to as a first lower shield layer, the second shield layer 461 of the lower reader 701 can be referred to as a second lower shield layer, and the nonmagnetic spacer layer 362 of the lower reader 701 can be referred to as a lower nonmagnetic spacer layer. As shown in FIG. 7, the lower shield layer 318 and the second lower shield layer 461 of the lower reader 701 can be considered at least part of an upper shield of the lower reader 701.

As another example, the magnetic seed layer 312 of the upper reader 702 can be referred to as an upper magnetic seed layer, the second magnetic seed layer 361 of the upper reader 702 can be referred to as a second upper magnetic seed layer, and the nonmagnetic spacer layer 362 of the upper reader 702 can be referred to as an upper nonmagnetic spacer layer. Each magnetic seed layer 312 includes a platform 341 protruding in the down-track direction.

In the implementation of the read head 700 shown in FIG. 7, the first AFM layer 343 of the upper reader 702 can be referred to as a third AFM layer disposed between the second upper magnetic seed layer 361 (of the upper reader 702) and the second AFM layer 319 (of the lower reader 701). The second AFM layer 319 of the upper reader 702 can be referred to as a fourth AFM layer. The third AFM layer and the fourth AFM layer are used in addition to the first AFM layer 343 and the second AFM layer 319 of the lower reader 701.

The read head 700 includes a middle shield layer disposed between the second AFM layer 319 (of the lower reader 701) and the third AFM layer (which is the first AFM layer 343 of the upper reader 702). In the implementation shown in FIG. 7, the middle shield layer is a bottom shield layer 311 of the upper reader 702, and the middle shield layer, the magnetic seed layer 312 of the upper reader 702, and the second magnetic seed layer 361 are at least part of a bottom shield of the upper reader 702.

The first AFM layer 343 (of the lower reader 701) interfaces with the lower magnetic seed layer (which is the magnetic seed layer 312 of the lower reader 701). The second AFM layer 319 (of the lower reader 701) interfaces with the second lower shield layer (which is the second shield layer 461 of the lower reader 701). The third AFM layer (which is the first AFM layer 343 of the upper reader 702) interfaces with the second upper magnetic seed layer (which is the second magnetic seed layer 361 of the upper reader 702), and optionally interfaces with the middle shield layer (which is the bottom shield layer 311 of the upper reader 702). The present disclosure contemplates that a non-magnetic layer can be disposed between the third AFM layer and the middle shield layer such that the third AFM layer interfaces with the non-magnetic layer. The fourth AFM layer (which is the second AFM layer 319 of the upper reader 702) interfaces with the upper shield layer (which is the shield layer 318 of the upper reader 702).

As shown by magnetization M8, the magnetic seed layer 312 of the upper reader 702 is magnetized in a direction (e.g., the second direction D2) that is opposite of the magnetization M1 of the magnetic seed layer 312 of the lower reader 701. As shown by magnetizations M9, M10, the shield layer 318 and the second magnetic seed layer 361 of the upper reader 702 are magnetized in a direction (e.g., the first direction D1) that is that same as the magnetization M1 of the magnetic seed layer 312 of the lower reader 601. Magnetization M9 and magnetization M8 of the upper reader 702 are antiparallel with each other, and magnetization M2 and magnetization M1 of the lower reader 701 are antiparallel with each other, as shown in FIG. 7.

The implementation shown in FIG. 7 includes two SAF pinning arrangements (involving the second AFM layer and the third AFM layer) at interfaces between the lower reader 701 and the upper reader 702, and two simple pinning arrangements (involving the first AFM layer and the fourth AFM layer) outwardly of the lower reader 701 and the upper reader 702. Such an implementation (e.g., using simple pinning on one side of each reader and using SAF pinning on the other side of each reader) facilitates using smaller downtrack separation while reducing or eliminating imbalances of read side bump signal amplitudes when using the lower reader 701 and the upper reader 702. Such an implementation also facilitates using a simple annealing and/or cooling operation to reset the magnetizations of the AFM layers of the read head 700, such as a single annealing and/or cooling operation to reset the magnetizations of all AFM layers of the read head 700.

In the implementation shown in FIG. 7, the first AFM layer pins the magnetic seed layer 312 of the lower reader 701, the second AFM layer pins the second shield layer 461 of the lower reader 701, the third AFM layer pins the second magnetic seed layer 361 of the upper reader 702, and the fourth AFM layer pins the shield layer 318 of the upper reader 702.

Example materials of the various layers in the above embodiments shown in FIGS. 3-7 will now be further described.

The cap layers 317 are non-ferromagnetic. The cap layers 317 are formed of one or more of tantalum (Ta), titanium (Ti), ruthenium (Ru), cobalt-hafnium (CoHf) and/or CoB. The cap layers 317 can each include a multilayer structure having layers formed of one or more of tantalum (Ta), titanium (Ti), ruthenium (Ru), and/or cobalt-hafnium (CoHf). The free layers 314, 316 are ferromagnetic.

The free layers 314, 316, are formed of one or more of cobalt (Co), iron (Fe), boron (B), nickel (Ni), and/or hafnium (Hf). The barrier layers 315 are formed of MgO. The insulation material 338 and the insulating separation layer 621 are each formed of aluminum oxide (AlOx), magnesium oxide (MgO), silicon nitride (SiN), silicon dioxide (SiO2), and/or other suitable insulation material(s).

The magnetic seed layers 312 and the second magnetic seed layers 361 are each formed of one or more of nickel-iron (NiFe), cobalt-iron (CoFe), (cobalt-boron) CoB, cobalt-iron-boron (CoFeB), and/or cobalt-hafnium (CoHf). The non-magnetic seed layers 313 are each formed of one or more or more of tantalum (Ta), titanium (Ti), ruthenium (Ru), cobalt-hafnium (CoHf), and/or CoB. Other materials can be used for the seed layers 312, 313, 361.

The first and second soft bias side shields 335a-335b, 336a-335b are magnetic and conductive. The first and second soft bias side shields 335a-335b, 336a-335b are formed of nickel-iron (NiFe) and/or CoFe.

The spacer layers 337a, 337b are formed of a nonmagnetic spacer material that is electrically conductive. In one or more embodiments, the spacer layers 337a, 337b are formed of ruthenium (Ru). In one or more embodiments, the spacer layers 337a, 337b are formed of one or more of titanium (Ti), chromium (Cr), iridium (Ir), and/or chromium-ruthenium (CrRu).

In one or more embodiments, the nonmagnetic spacer layer 362 is formed of ruthenium (Ru). In one or more embodiments, the nonmagnetic spacer layer 362 is formed of one or more of titanium (Ti), chromium (Cr), iridium (Ir), and/or chromium-ruthenium (CrRu).

The shield layers 311, 318, 461 are each formed of one or more of nickel-iron (NiFe), cobalt-iron (CoFe), (cobalt-boron) CoB, cobalt-iron-boron (CoFeB), and/or cobalt-hafnium (CoHf). Other materials can be used for the shield layers 311, 318, 461.

In one or more embodiments, each of the AFM layers 319, 343 is formed of manganese (Mn) and/or one of iridium (Ir), iron (Fe), or platinum (Pt), such as plated manganese and/or iridium manganese (IrMn). Other materials are contemplated for the AFM layers.

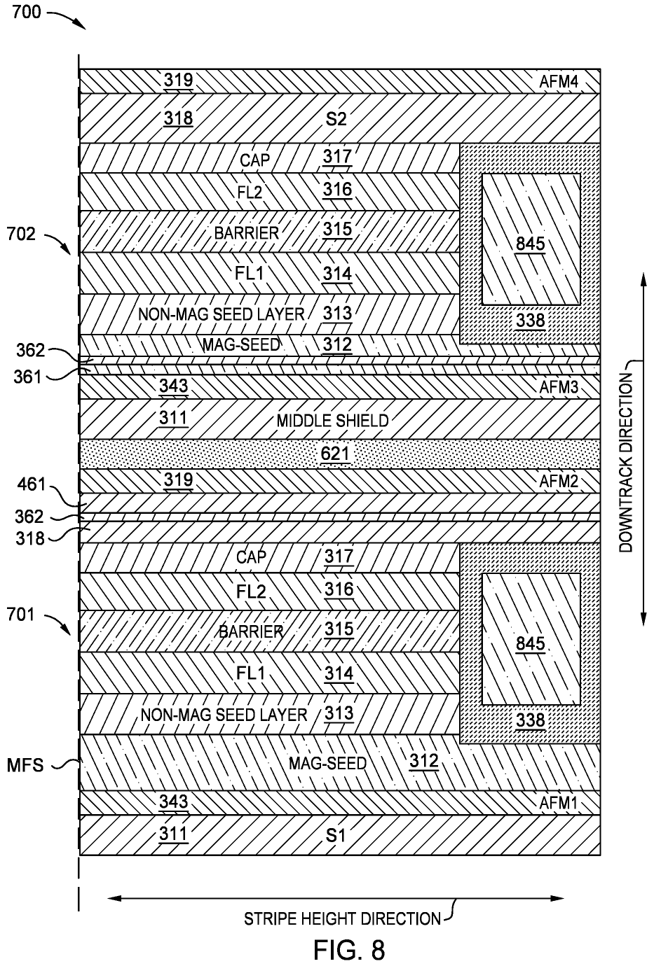

FIG. 8 is a schematic cross-sectional side view of the read head 700 shown in FIG. 7, according to one implementation. A respective rear hard bias layer 845 is disposed behind the layers 313-317 (along a stripe height direction) of each of the lower reader 701 and the upper reader 702. The rear hard bias layers 845 are each formed of cobalt platinum (CoPt) with appropriate seed layers.

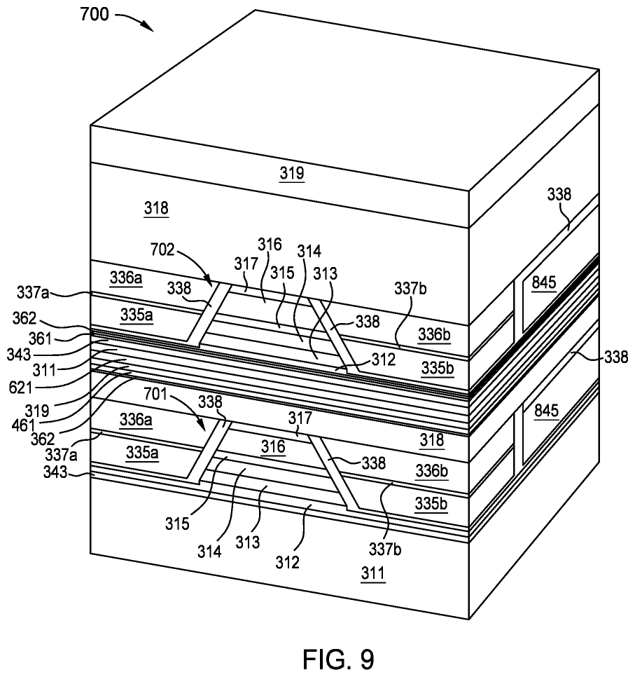

FIG. 9 is a schematic isometric view of the read head 700 shown in FIG. 7, according to one implementation.

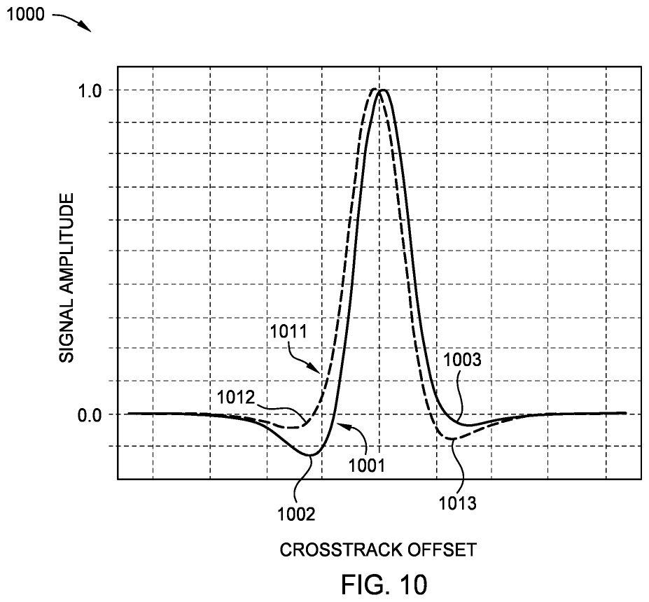

FIG. 10 is a schematic graphical view of a graph 1000 showing signal amplitude versus cross-track offset (e.g., cross-track profile) for two example DFL reader implementations. The signal amplitude can be an amplitude of a readback signal when the reader moves to a different cross-track location. The signal amplitude is normalized to center the amplitude between 0.0 and 1.0 (with 0.0 aligning with flat regions and 1.0 aligning with peak values), as shown in FIG. 10.

A first profile 1001 is generated using a DFL reader configuration other than those described herein. The first profile 1001 includes a first bump height 1002 on a left-hand side of a peak of the first profile 1001, and a second bump height 1003 on a right-hand side of the peak of the first profile 1001. This first profile is an example of the asymmetrical bump of a DFL cross-track signal profile mentioned above in the Related Art discussion.

A second profile 1011 is generated using an example DFL reader configuration made according to the subject matter described herein. The second profile 1011 includes a first bump height 1012 on a left-hand side of a peak of the second profile 1011, and a second bump height 1013 on a right-hand side of the peak of the second profile 1011.

A first difference between the first bump height 1002 and the second bump height 1003 is larger in the first profile 1001 than a second difference between the first bump height 1012 and the second bump height 1013 of the second profile 1011. The second profile 1011 thus exhibits a smaller imbalance (e.g., a smaller difference between bumps). As discussed above and also further below, this smaller imbalance minimizes the write quality differential that is dependent upon the shingling direction in SMR.

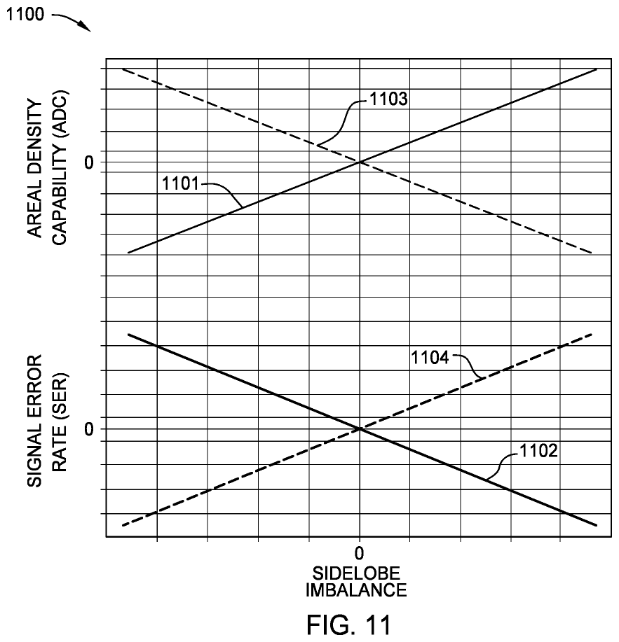

FIG. 11 is a schematic graphical view of a graph 1100 showing areal density capability (ADC) and sector error rate (SER), respectively, versus cross-track signal sidebump (e.g., sidelobe) imbalance. The Y-axis for the ADC and the SER shown in FIG. 11 shows the delta (e.g. difference) between two shingle directions under an SMR recording operation.

A first profile 1101 shows a delta-ADC versus signal sidebump imbalance. A second profile 1102 shows delta-SER versus signal sidebump imbalance. The sidebump imbalance can refer to the difference of bump height between two bumps along a signal amplitude profile (such as one of the two profiles shown in FIG. 10). As shown by the first profile 1101, sidebump imbalance (e.g., reducing the bump difference between two bumps on two sides of a peak) reduces the delta-ADC between two shingle directions. As shown by the second profile 1102, reducing signal imbalance reduces the delta-SER between two shingle directions.

Profiles 1101 and 1102 show information for one type of head, such as a head facing down towards a medium. The slope directions of the profiles may be reversed if the head is facing up towards the medium, as shown for profiles 1103, 1104 in FIG. 11. The intersection of profiles 1101, 1103, and the intersection of profiles 1102, 1104 are aligned with a location where the signal imbalance is zero or nearly zero.

In certain embodiments, the head orientation (faces up or down) dictates the shingle direction in SMR. Using a dual free layer reader can exacerbate issues with larger delta-ADC and/or larger delta-SER across two different heads (facing down and facing up) due to larger sidebump imbalance. However, using subject matter described herein the sidebump imbalance be reduced such that ADC differences and SER differences reduce and are independent of the shingle direction, even if dual free layer readers are used for reading operations.

For example, the magnetization of the magnetic seed layer 312 being antiparallel to the magnetization of the shield layer 318 facilitates reducing or eliminating signal sidebump imbalance to achieve more uniform recording density across whole disk surfaces and across different heads (e.g., heads facing up vs. heads facing down) Benefits of the present disclosure include enhanced ADC, increased device performance uniformity (e.g., across an entire medium surface); reduced SER; smaller downtrack separations; reduced imbalances of read sidebump signal amplitudes; and using simple annealing and/or cooling operations to reset magnetizations of reader layers (such as a single annealing and/or cooling operation to reset the magnetizations of all AFM layers of a read head).

It is contemplated that one or more aspects disclosed herein may be combined. As an example, the present disclosure contemplates that aspects of the magnetic media drive 100, the head assembly 200, the reader 300, the reader 400, the reader 500, the read head 600, the read head 700, the graph 1000, and/or the graph 1100 may be combined. Moreover, it is contemplated that one or more aspects disclosed herein may include some or all of the aforementioned benefits.

In one implementation, a reader for magnetic recording devices includes a magnetic seed layer magnetized in a first direction, a shield layer magnetized in a second direction that is opposite of the first direction, and a first free layer disposed between the magnetic seed layer and the shield layer. The reader includes a second free layer disposed between the first free layer and the shield layer, a barrier layer disposed between the first free layer and the second free layer, and a first antiferromagnetic (AFM) layer disposed outwardly of the magnetic seed layer relative to the barrier layer. The reader includes a second AFM layer disposed outwardly of the shield layer relative to the barrier layer. The reader includes a first set of soft bias side shield layers between the magnetic seed layer and the shield layer, a second set of soft bias side shield layers between the first set of soft bias side shield layers and the shield layer, and a set of nonmagnetic spacer layers between the first set of soft bias side shield layers and the second set of soft bias side shield layers. The set of nonmagnetic spacer layers are formed of a nonmagnetic spacer material that is electrically conductive. The reader includes a nonmagnetic seed layer disposed between the magnetic seed layer and the first free layer, and a cap layer disposed between the second free layer and the shield layer. In one or more embodiments, the nonmagnetic spacer material is ruthenium (Ru). A thickness of each of the set of nonmagnetic spacer layers is less than 10 Angstroms. The reader includes an insulation material between the first set of soft bias side shield layers and the magnetic seed layer. The first AFM layer has a first blocking temperature and the second AFM layer has a second blocking temperature that is different than the first blocking temperature. The first AFM layer interfaces with the magnetic seed layer, and the second AFM layer interfaces with the shield layer. The reader includes a second magnetic seed layer disposed between the magnetic seed layer and the first AFM layer. The second magnetic seed layer is magnetized in the second direction. The reader includes a nonmagnetic spacer layer disposed between the magnetic seed layer and the second magnetic seed layer. The reader includes a second shield layer disposed between the shield layer and the second AFM layer. The second shield layer is magnetized in the second direction. The reader includes a nonmagnetic spacer layer disposed between the shield layer and the second shield layer. A magnetic recording device including the reader is also disclosed.

In one implementation, a read head for magnetic recording devices includes a lower reader. The lower reader includes a lower magnetic seed layer magnetized in a first direction, a lower shield layer magnetized in a second direction that is opposite of the first direction, and a first lower free layer disposed between the lower magnetic seed layer and the lower shield layer. The lower reader includes a second lower free layer disposed between the first lower free layer and the lower shield layer, a lower barrier layer disposed between the first lower free layer and the second lower free layer, and a first antiferromagnetic (AFM) layer disposed outwardly of the lower magnetic seed layer relative to the lower barrier layer. The lower reader includes a second AFM layer disposed outwardly of the lower shield layer relative to the lower barrier layer. The read head includes an upper reader. The upper reader includes an upper magnetic seed layer magnetized in the second direction, an upper shield layer magnetized in the first direction, and a first upper free layer disposed between the upper magnetic seed layer and the upper shield layer. The upper reader includes a second upper free layer disposed between the first upper free layer and the upper shield layer, and an upper barrier layer disposed between the first upper free layer and the second upper free layer. The upper reader includes a third AFM layer disposed between the upper magnetic seed layer and the second AFM layer, and a fourth AFM layer disposed outwardly of the upper shield layer relative to the upper barrier layer. The read head includes a middle shield layer and an insulating separation layer disposed between the second AFM layer and the third AFM layer. The lower reader further includes a second lower magnetic seed layer disposed between the lower magnetic seed layer and the first AFM layer. The second lower magnetic seed layer is magnetized in the second direction. The lower reader includes a lower nonmagnetic spacer layer disposed between the lower magnetic seed layer and the second lower magnetic seed layer. The upper reader includes a second upper shield layer disposed between the upper shield layer and the fourth AFM layer. The second upper shield layer is magnetized in the second direction. The upper reader includes an upper nonmagnetic spacer layer disposed between the upper shield layer and the second upper shield layer. The first AFM layer interfaces with the second lower magnetic seed layer. The second AFM layer interfaces with the lower shield layer and an insulating separation layer. The third AFM layer interfaces with the upper magnetic seed layer. The fourth AFM layer interfaces with the second upper shield layer. The lower reader includes a second lower shield layer disposed between the lower shield layer and the second AFM layer. The second lower shield layer is magnetized in the first direction. The lower reader includes a lower nonmagnetic spacer layer disposed between the lower shield layer and the second lower shield layer. The upper reader includes a second upper magnetic seed layer disposed between the upper magnetic seed layer and the third AFM layer. The second upper magnetic seed layer is magnetized in the first direction. The upper reader includes an upper nonmagnetic spacer layer disposed between the upper magnetic seed layer and the second upper magnetic seed layer. The first AFM layer interfaces with the lower magnetic seed layer. The second AFM layer interfaces with the second lower shield layer. The third AFM layer interfaces with the middle shield layer and an insulating separation layer. The fourth AFM layer interfaces with the upper shield layer. A magnetic recording device including the read head is also disclosed.

In one implementation, a read head for magnetic recording devices includes a lower reader. The lower reader includes a lower magnetic seed layer magnetized in a first direction, a lower shield layer magnetized in a second direction that is opposite of the first direction, and a first lower free layer disposed between the lower magnetic seed layer and the lower shield layer. The lower reader includes a second lower free layer disposed between the first lower free layer and the lower shield layer, a first antiferromagnetic (AFM) layer disposed outwardly of the lower magnetic seed layer, and a second AFM layer disposed outwardly of the lower shield layer. The lower reader includes a first lower set of soft bias side shield layers between the lower magnetic seed layer and the lower shield layer. The first lower set of soft bias side shield layers are magnetized in the first direction. The lower reader includes a second lower set of soft bias side shield layers between the first lower set of soft bias side shield layers and the lower shield layer. The second lower set of soft bias side shield layers are magnetized in the second direction. The lower reader includes a set of lower nonmagnetic spacer layers between the first lower set of soft bias side shield layers and the second lower set of soft bias side shield layers. The lower reader includes lower insulation material disposed between the first and second lower free layers on a first side of the lower insulation material and the first and second lower sets of soft bias side shield layers on a second side of the lower insulation material. The read head includes an upper reader. The upper reader includes an upper magnetic seed layer magnetized in the second direction, an upper shield layer magnetized in the first direction, and a first upper free layer disposed between the upper magnetic seed layer and the upper shield layer. The upper reader includes a second upper free layer disposed between the first upper free layer and the upper shield layer, a third AFM layer disposed between the upper magnetic seed layer and the second AFM layer, and a fourth AFM layer disposed outwardly of the upper shield layer. The upper reader includes a first upper set of soft bias side shield layers between the upper magnetic seed layer and the upper shield layer. The first upper set of soft bias side shield layers are magnetized in the second direction. The upper reader includes a second upper set of soft bias side shield layers between the first upper set of soft bias side shield layers and the upper shield layer. The second upper set of soft bias side shield layers are magnetized in the first direction, and a set of upper nonmagnetic spacer layers between the first upper set of soft bias side shield layers and the second upper set of soft bias side shield layers. The upper reader includes upper insulation material disposed between the first and second upper free layers on a first side of the upper insulation material and the first and second upper sets of soft bias side shield layers on a second side of the upper insulation material. A first thickness of the lower nonmagnetic spacer layers is less than 10 Angstroms. A second thickness of the upper nonmagnetic spacer layers is less than 10 Angstroms. Each of the first lower free layer, the second lower free layer, the first upper free layer, and the second upper free layer includes one or more of: cobalt (Co), iron (Fe), boron (B), nickel (Ni), and/or hafnium (Hf). Each of the lower magnetic seed layer and the upper magnetic seed layer includes one or more of: nickel-iron (NiFe), cobalt-iron (CoFe), (cobalt-boron) CoB, cobalt-iron-boron (CoFeB), and/or cobalt-hafnium (CoHf). Each of the first AFM layer, the second AFM layer, the third AFM layer, and the fourth AFM layer incudes manganese (Mn) one of iridium (Ir) iron, (Fe), or platinum (Pt). A magnetic recording device including the read head is also disclosed.

While the foregoing is directed to embodiments of the present disclosure, other and further embodiments of the disclosure may be devised without departing from the basic scope thereof, and the scope thereof is determined by the claims that follow.

What is claimed is:

1. A reader for magnetic recording devices, comprising:
a magnetic seed layer magnetized in a first direction;
a shield layer magnetized in a second direction that is opposite of the first direction;
a first free layer disposed between the magnetic seed layer and the shield layer;
a second free layer disposed between the first free layer and the shield layer;
a barrier layer disposed between the first free layer and the second free layer;
a first antiferromagnetic (AFM) layer disposed outwardly of the magnetic seed layer relative to the barrier layer;
a second AFM layer disposed outwardly of the shield layer relative to the barrier layer;
a first set of soft bias side shield layers between the magnetic seed layer and the shield layer;
a second set of soft bias side shield layers between the first set of soft bias side shield layers and the shield layer; and
a set of nonmagnetic spacer layers between the first set of soft bias side shield layers and the second set of soft bias side shield layers, the set of nonmagnetic spacer layers formed of a nonmagnetic spacer material that is electrically conductive.

2. The reader of claim 1, further comprising:
a nonmagnetic seed layer disposed between the magnetic seed layer and the first free layer; and
a cap layer disposed between the second free layer and the shield layer.

3. The reader of claim 1, wherein the nonmagnetic spacer material is ruthenium (Ru).

4. The reader of claim 1, wherein a thickness of each of the set of nonmagnetic spacer layers is less than 10 Angstroms.

5. The reader of claim 1, further comprising an insulation material between the first set of soft bias side shield layers and the magnetic seed layer.

6. The reader of claim 1, wherein the first AFM layer has a first blocking temperature and the second AFM layer has a second blocking temperature that is different than the first blocking temperature.

7. The reader of claim 1, wherein the first AFM layer interfaces with the magnetic seed layer, and the second AFM layer interfaces with the shield layer.

8. The reader of claim 1, further comprising:
a second magnetic seed layer disposed between the magnetic seed layer and the first AFM layer, wherein the second magnetic seed layer is magnetized in the second direction; and
a nonmagnetic spacer layer disposed between the magnetic seed layer and the second magnetic seed layer.

9. The reader of claim 1, further comprising:
a second shield layer disposed between the shield layer and the second AFM layer, wherein the second shield layer is magnetized in the first direction; and
a nonmagnetic spacer layer disposed between the shield layer and the second shield layer.

10. A magnetic recording device comprising the reader of claim 1.

11. A read head for magnetic recording devices, comprising:
a lower reader comprising:
a lower magnetic seed layer magnetized in a first direction,
a lower shield layer magnetized in a second direction that is opposite of the first direction,
a first lower free layer disposed between the lower magnetic seed layer and the lower shield layer,
a second lower free layer disposed between the first lower free layer and the lower shield layer,
a lower barrier layer disposed between the first lower free layer and the second lower free layer,
a first antiferromagnetic (AFM) layer disposed outwardly of the lower magnetic seed layer relative to the lower barrier layer, and
a second AFM layer disposed outwardly of the lower shield layer relative to the lower barrier layer; and
an upper reader, the upper reader comprising:
an upper magnetic seed layer magnetized in the second direction,
an upper shield layer magnetized in the first direction,
a first upper free layer disposed between the upper magnetic seed layer and the upper shield layer,
a second upper free layer disposed between the first upper free layer and the upper shield layer,
an upper barrier layer disposed between the first upper free layer and the second upper free layer,
a third AFM layer disposed between the upper magnetic seed layer and the second AFM layer, and
a fourth AFM layer disposed outwardly of the upper shield layer relative to the upper barrier layer.

12. The read head of claim 11, further comprising a middle shield layer and an insulating separation layer disposed between the second AFM layer and the third AFM layer.

13. The read head of claim 12, wherein:
the lower reader further comprises:
a second lower magnetic seed layer disposed between the lower magnetic seed layer and the first AFM layer, wherein the second lower magnetic seed layer is magnetized in the second direction, and
a lower nonmagnetic spacer layer disposed between the lower magnetic seed layer and the second lower magnetic seed layer; and
the upper reader further comprises:
a second upper shield layer disposed between the upper shield layer and the fourth AFM layer, wherein the second upper shield layer is magnetized in the second direction, and
an upper nonmagnetic spacer layer disposed between the upper shield layer and the second upper shield layer.

14. The read head of claim 13, wherein:
the first AFM layer interfaces with the second lower magnetic seed layer;
the second AFM layer interfaces with the lower shield layer and the middle shield layer and the insulating separation layer;
the third AFM layer interfaces with the upper magnetic seed layer; and
the fourth AFM layer interfaces with the second upper shield layer.

15. The read head of claim 12, wherein:
the lower reader further comprises:
a second lower shield layer disposed between the lower shield layer and the second AFM layer, wherein the second lower shield layer is magnetized in the first direction, and
a lower nonmagnetic spacer layer disposed between the lower shield layer and the second lower shield layer; and
the upper reader further comprises:
a second upper magnetic seed layer disposed between the upper magnetic seed layer and the third AFM layer, wherein the second upper magnetic seed layer is magnetized in the first direction, and
an upper nonmagnetic spacer layer disposed between the upper magnetic seed layer and the second upper magnetic seed layer.

16. The read head of claim 15, wherein:
the first AFM layer interfaces with the lower magnetic seed layer;
the second AFM layer interfaces with the second lower shield layer and the insulating separation layer;
the third AFM layer interfaces with the second upper magnetic seed layer; and
the fourth AFM layer interfaces with the upper shield layer.

17. A magnetic recording device comprising the read head of claim 11.

18. A read head for magnetic recording devices, comprising:
a lower reader comprising:
a lower magnetic seed layer magnetized in a first direction,
a lower shield layer magnetized in a second direction that is opposite of the first direction,
a first lower free layer disposed between the lower magnetic seed layer and the lower shield layer,
a second lower free layer disposed between the first lower free layer and the lower shield layer,
a first antiferromagnetic (AFM) layer disposed outwardly of the lower magnetic seed layer,
a second AFM layer disposed outwardly of the lower shield layer,
a first lower set of soft bias side shield layers between the lower magnetic seed layer and the lower shield layer, wherein the first lower set of soft bias side shield layers are magnetized in the first direction,
a second lower set of soft bias side shield layers between the first lower set of soft bias side shield layers and the lower shield layer, wherein the second lower set of soft bias side shield layers are magnetized in the second direction,
a set of lower nonmagnetic spacer layers between the first lower set of soft bias side shield layers and the second lower set of soft bias side shield layers, and
lower insulation material disposed between the first and second lower free layers on a first side of the lower insulation material and the first and second lower sets of soft bias side shield layers on a second side of the lower insulation material; and
an upper reader, the upper reader comprising:
an upper magnetic seed layer magnetized in the second direction,
an upper shield layer magnetized in the first direction,
a first upper free layer disposed between the upper magnetic seed layer and the upper shield layer,
a second upper free layer disposed between the first upper free layer and the upper shield layer,
a third AFM layer disposed between the upper magnetic seed layer and the second AFM layer,
a fourth AFM layer disposed outwardly of the upper shield layer,
a first upper set of soft bias side shield layers between the upper magnetic seed layer and the upper shield layer, wherein the first upper set of soft bias side shield layers are magnetized in the second direction,
a second upper set of soft bias side shield layers between the first upper set of soft bias side shield layers and the upper shield layer, wherein the second upper set of soft bias side shield layers are magnetized in the first direction, and
a set of upper nonmagnetic spacer layers between the first upper set of soft bias side shield layers and the second upper set of soft bias side shield layers, and upper insulation material disposed between the first and second upper free layers on a first side of the upper insulation material and the first and second upper sets of soft bias side shield layers on a second side of the upper insulation material.

19. The read head of claim 18, wherein:
a first thickness of the lower nonmagnetic spacer layers is less than 10 Angstroms;
a second thickness of the upper nonmagnetic spacer layers is less than 10 Angstroms;
each of the first lower free layer, the second lower free layer, the first upper free layer, and the second upper free layer comprises one or more of: cobalt (Co), iron (Fe), boron (B), nickel (Ni), or hafnium (Hf);
each of the lower magnetic seed layer and the upper magnetic seed layer comprises one or more of: nickel-iron (NiFe), cobalt-iron (CoFe), (cobalt-boron) CoB, cobalt-iron-boron (CoFeB), or cobalt-hafnium (CoHf); and
each of the first AFM layer, the second AFM layer, the third AFM layer, and the fourth AFM layer comprises manganese (Mn) and one of iridium (Ir), iron (Fe), or platinum (Pt).

20. A magnetic recording device comprising the read head of claim 18.
